(19) United States
(12) Patent Application Publication
(10) Pub. No.: US 2009/0106296 A1
(43) Pub. Date: Apr. 23, 2009

(54) Method and system for automated form aggregation

(75) Inventors: David Jonathan Sickmiller, Jackson, MI (US); Jonathan Leighton Brown, Howell, MI (US)

Correspondence Address: Career Liaison, LLC, 10205 Crossview Tr, Howell, MI, 48855, US

(73) Assignee: Career Liaison, LLC

(21) Appl. No.: 11/975,444

(22) Filed: Oct. 19, 2007

(51) Int. Cl. G06F 17/30

(52) U.S. Cl. 707/102; 707/E17.118

(57) ABSTRACT

The present invention relates to the field of computer software. More specifically, the present invention relates to methods of assisting aggregation of form-enabled web services. Systems and methods for handling the submission of user data into a plurality of form-enabled web sites are disclosed. The improved system allows for the presentation of a unified user interface, pre-filling of forms in order to increase user efficiency, and a fully automatic interface to the aggregated form-enabled web services.

### FIELD OF THE INVENTION

The present invention relates in general to internet communications systems. More specifically, the present invention relates to systems and methods for submitting form data over HyperText Transport Protocol (HTTP).

### BACKGROUND OF THE INVENTION

In the typical usage of the web, specialized HTTP clients, commonly instantiated as web browsers, are utilized by end-users to access HTTP documents located on servers residing on the internet. Web browser clients vary in functionality, but typically receive HTTP messages and render encapsulated content into a visual representation for view by the user of the client software. In modern web usage, the encapsulated document is likely one that is specified in HyperText Markup Language (HTML), in combination with Javascript, Cascading Style Sheets (CSS), and embedded binary image formats.

HTML contains many provisions for structuring the content of the page, in terms of layout and interaction. One of the central mechanisms for interaction on the web is by way of form submissions, which are specialized, multi-fielded requests that are commonly larger than standard GET type requests. Form submissions can be implemented as either GET or POST requests in HTTP. Currently, the layout and structure of a form is specified in HTML by way of a form tag in the HTML document, enclosing the specification of the fields. The web browser client software is able to parse the form tag specification and renders the display of the form to the end user, which will vary in appearance depending on the implementation of the browser. Form presentations as rendered by a web browser typically contain the labels of each form field, along with a control to allow user input, such as a text field, drop-down box, radio button, or push button.

Because of the large, and growing, number of sites on the web, specialized aggregator sites have been evolved in order to organize and categorize sites of similar content. These species of site are also known in the art as portals, vertical search engines, theme sites, as well as many other names. Besides aggregating content, aggregations of sites that support form submissions are also becoming increasingly important and prevalent. Examples of this category of sites familiar to those of skill in the art include meta-search engines, job search sites, comparison shopping engines, local restaurant information, and many others.

The central problem with aggregating multiple form-enabled sites is in presenting a unified interface to the user when each individual form-enabled site may have its own disparate interface. Not only are the styling and layout of the forms different on each site, the names and types of the fields in the forms may differ even on sites of like interest. For example, one site may require form submissions to specify ZIP codes whereas another site may require city-state pairs, and the fields may be given different names. These input controls may also look significantly different because of the individual sites' CSS styling rules or look-and-feel.

One approach to addressing the problem of aggregating multiple form-enabled websites is to present the end user with a single form, receive the form data from the user's web browser client, and then manually relay the user information to the relevant form-enabled sites. FIG. 1 is a simplified block diagram illustrating an exemplary architecture of such a system 100. In this system 100, the end user enters the information and criteria that he is interested in into a form displayed on his web browser client 102 that was sent by an HTTP server 104. The HTTP server 104 then receives the form data sent by the web browser client software 102. The HTTP server 104 may then have access or integration with a site index 106, which contains a list of the relevant services to the user's request. The site index 106 may be implemented in various ways, such as using a relational database management system or by flat file that has been loaded into memory. The site index 106 is indexed by the attributes that the user desires to filter by, such as type, location, price, category, etc. These attributes will be dependent on the aggregator domain. The user-submitted form data is then read from the server 104 along with the list of relevant sites by a human operator. The operator understands the information and then relays the information to a plurality of relevant form-enabled services 108-114, as indicated by the dashed directional arrow in the FIG. 1.

A disadvantage of this approach is that manual intervention is involved, which is disadvantageous when a prompt action or confirmation is desired. One specific example of a category of form aggregator site that would be enabled by this approach is restaurant concierge services. In this particular domain application, many restaurants and food services have online order-taking means via form submissions. However, each restaurant may employ a different form layout and specification. An aggregator service of restaurants, such as a delivery service, would then present a single form interface on its own website to the end user, collect the user's order, and then manually place the order on each restaurant's website. While this approach makes the interface from the end user's side unified and streamlined, it places a burden of manual work on the aggregator's side, effectively preventing the aggregator for scaling up to a moderately large number of form-enabled services.

FIG. 2 shows the simplified block diagram architecture of another system 200, whereby the client web browser software also interacts in like manner with an aggregator HTTP server 204 that has access to a similarly configured site index 206. However, in this case, the aggregator does not itself execute the transaction, but returns to the client a list of relevant sites to the user's query, drawn from its site index 206. The user then navigates using the client web browser software to the plurality of sites 208-214, as indicated by the dashed directional arrows. On each of the form-enabled web sites, the user interacts with the form given at each site, manually entering in his information and criterion himself. He repeats this process for the forms on each of the form-enabled sites 208-210 that he is interested in.

An example of a category of aggregator site that employs this type of system architecture 200 is job search engine sites. Typically the end user, the job seeker in this case, accesses the aggregator site 204 from his web browser client software 202 and seeks a list of jobs from the index 206 that match a particular set of preconceived criterion, which may include categories indexed on such fields as salary, location, and title. The aggregator server 204 then returns a result list of jobs, typically in the form of Uniform Resource Locators (URLs) in conjunction with a brief title and other short descriptive fields. The job seeker then navigates the URLs of each of the form-enabled employer websites 208-214 that he is interested in applying to a job at. Each employer website will have its own form with its own user interface and customized fields. The employer applicant system form may employ such customizations as login authentication systems or résumé upload templates.

While such a system 200 allows the aggregator site to index a potentially large number of form-enabled sites, resulting in a more comprehensive search, the practical number of sites that the user can submit his personal information to is limited by the manual effort the user must perform in order to submit to each of the form-enabled sites that he is interested in. The user is constrained by the amount of time required to download, understand, and submit each of the disparate forms on each of the employer job sites. Furthermore, much of the user's effort is redundant since he has to enter largely the same information at each of the form-enabled websites that he wishes to submit his information to.

As both systems described above illustrate, inefficiency exists in how current systems handle aggregating submissions to multiple form-enabled websites that have forms with essentially similar content, but with heterogeneous format and display. Currently, there is an undesirable tradeoff between having a unified end user interface, with a complicated, manual process on the aggregator side and having a simple, scalable aggregator side with a complex, time-consuming user process. Both sides of this system design tradeoff are undesirable because both situations limit the scalability of the system, either by limiting the number of sites that the service can effectively aggregate, or by limiting the number of submissions that the user is able to complete.

Therefore, it would be highly desirable to have a system for a multiple form aggregation environment that allows both a unified user interface that minimizes the amount of effort required of the end user, while having a fully-automatic system that interfaces an unlimited number of form-enabled services.

### BRIEF SUMMARY OF THE INVENTION

Various methods for constructing a system for assisting aggregation of form-enabled sites are disclosed. Unlike the prior art systems for aggregation of form-enabled sites presented above, the disclosed invention allows for a unified user interface, which dramatically increases the ease in which the user of the system interacts with the aggregator and increases the number of submissions that the user of the system can make by allowing the user to complete forms more efficiently. Simultaneously, the system operates in a fully automated manner, removing the need for a human administrator, thereby allowing the system to expand the number of form-enabled sites that are aggregated, thereby providing a service that is more comprehensive and hence, more useful.

### BRIEF DESCRIPTION OF THE DRAWINGS

The present invention may be further understood from the following description in conjunction with the appended drawings. In the drawings:

FIG. 1 is a simplified block diagram showing a system for multiple form submission that requires manual work on the server side to interact with several form enabled services;

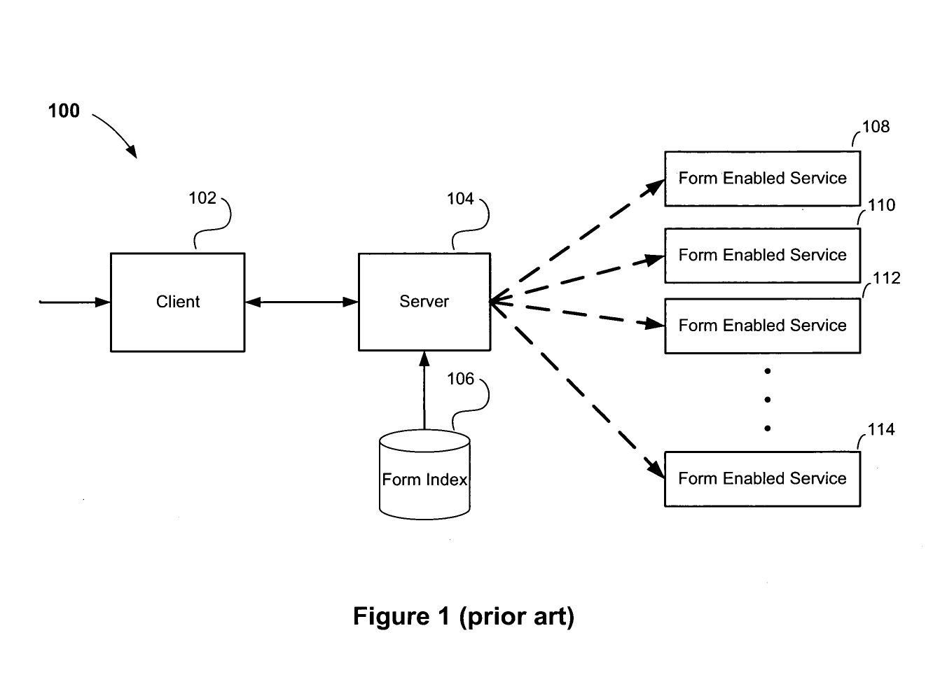

FIG. 2 is a simplified block diagram showing a system for multiple form submission that requires the client to manually interact with several form enabled services;

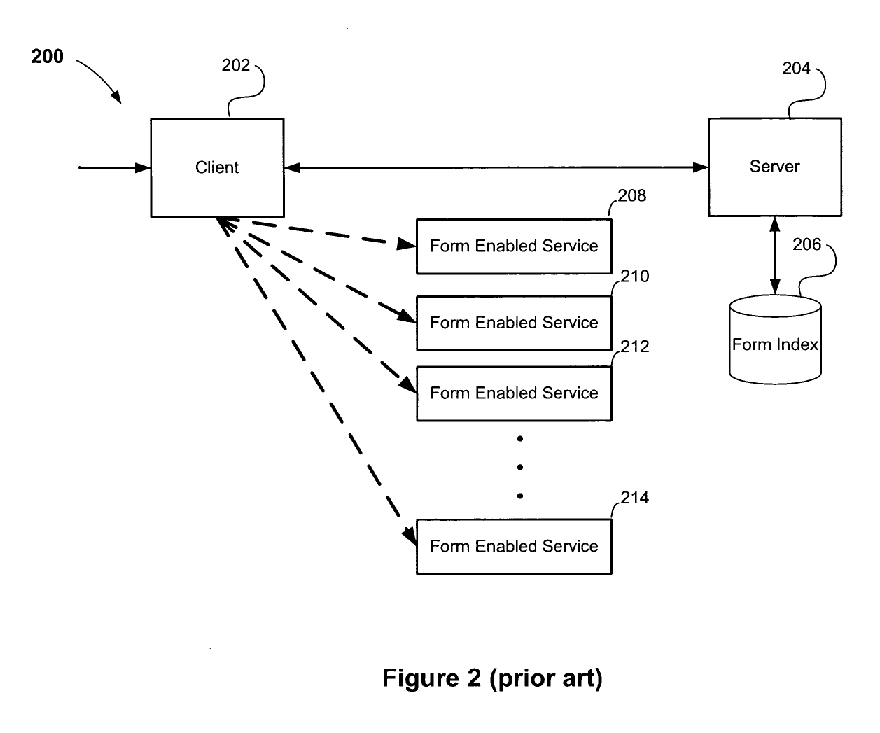

FIG. 3 is a simplified block diagram of a fully automated multiple form submission system, capable of interacting with several form enabled services, which comprises a form processor, stored form cache, user profile database, and agent array;

FIG. 4 is a simplified schematic diagram of an exemplary form processor component, wherein said form processor component interfaces the client and interacts with the agent array component and comprises a HTTP server, fall-back handler, site identifier, user form component, form cache, form index, and user profile data storage subsystem;

FIG. 5 is a flowchart illustrating the steps for retrieving a specified form (i.e. handling a GET request), such as that executed by the form processor of FIG. 4;

FIG. 6 is a flowchart illustrating the steps for submitting a specified form (i.e. handling a SUBMIT request), such as that executed by the form processor of FIG. 4;

FIG. 7 is a simplified schematic diagram of an exemplary agent component, of which a plurality form the agent array of the FIG. 3, comprising a request parser, field extractor, web rendering engine, DOM manipulator, submitter component, and multi-page handler;

FIG. 8 is a flowchart illustrating the steps for extracting a form specification, such as which may be employed by an exemplary agent component of FIG. 7; and

FIG. 9 is a flowchart illustrating the steps for submitting a user form via the agent component interface, such as which may be employed by an exemplary agent component of FIG. 7.

### DETAILED DESCRIPTION

It is desirable to have an aggregation service operable such that no manual work performed by a human operator of the aggregation service is required in order to handle an end user request. This allows the request to be completed much more quickly, while the user is still on the system, thus removing the need for a delayed or call-back confirmation.

An automatic form interface manager for an aggregator allows for a unified presentation of the form, tighter integration with the form-enabled services, and development of an end user profile based on past form submissions. An automatic form interface manager is a specialized system for obtaining, managing, and submitting forms across several form-enabled services. By analyzing the structure of the forms existing on the aggregated sites instead of only indexing at the URL (page) level, an aggregator employing an automatic form interface manager is able to represent the various forms in a normalized manner, referred to as the form specification, which results in many benefits. Such benefits include, but are not limited to, creating a consistent look-and-feel for forms, even though the forms may have come from different websites, pre-filling the values of the fields in the form, in order to save the end user time, and automatically submitting user data across several forms of the same subject matter.

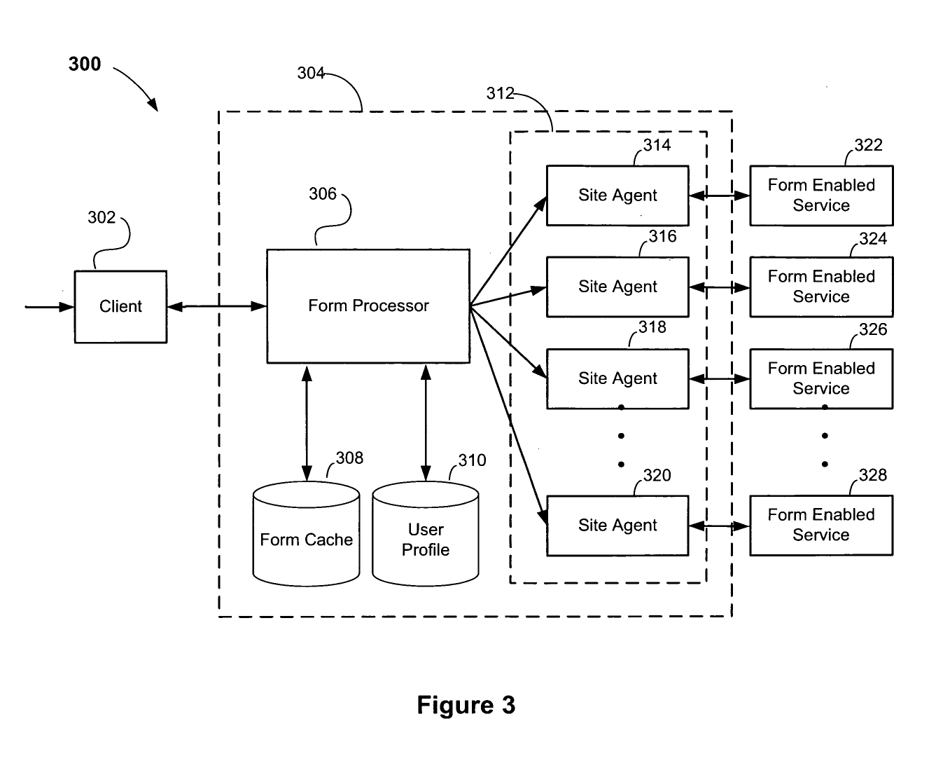

FIG. 3 shows a simplified block diagram of an embodiment of an automatic form interface management system 300. The automatic form interface manager 304 comprises a form processor 306, site form cache (form index) 308, user profile database 310 and an agent array 312. The agent array 312 further comprises a series of randomly addressable site-specific agent components 314-320, each of the site-specific agent components being used to interface one of the form-enabled services 322-328. Although, a limited number of agent components have been depicted for the purposes of this figure, it is readily appreciated by one skilled in the art that any number of agent components may be contained in the array, in order to accommodate any number of aggregated form-enabled services.

In this embodiment of the invention, the end user accesses the system through a web browser client program 302, navigating to the internet address of the aggregation service employing an automatic form interface manager 304. The client's request is handled by a form processor component 306, which is associated with a form cache 308 and a user profile database 310. The form processor component is responsible for retrieving applications from the cache 308 or the agent array 312, pre-filling user data fields cached in the user profile database, as well as forwarding completed forms from the client 302 to the site array. Possible embodiments of the form processor 306 will be subsequently described in following sections. The agent array 312 comprises a plurality of agent components 314-320 arranged in series. The agent array 312 receives dispatch requests from the form processor of primarily two types: requests for form specifications (GET form requests) and completed form submissions (SUBMIT form requests). When these operation codes are received by the agent array 312, the messages are passed to the corresponding agent of interest, which handles the remainder of the transaction with the remote form-enabled service.

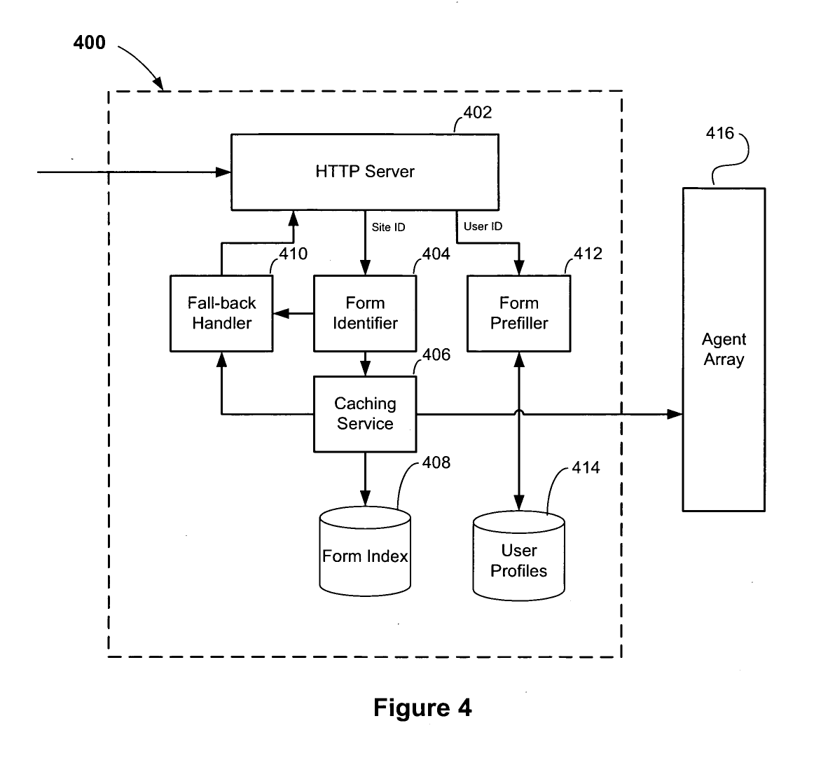

FIG. 4 is a simplified schematic diagram depicting further detail on a possible embodiment of the form processor 306 of FIG. 3. This embodiment of the form processor 400 comprises an HTTP server 402, communicating directly with a site identifier 404, and a form pre-filler 412. The form pre-filler has access to a user profile database 414. This user profile database 414 may be implemented in several ways, including as an instantiation of a relational database management system or as a hashtable structure loaded into memory, for example. The caching service 406 accesses the agent array 416 and communicates with a form index database 408, which may be combined with the user profile database 414, or implemented separately.

One embodiment of the form processor 306 operates by receiving requests from the client web browser on the HTTP server 402. The user requests will be of many types. However, two important types of operation requests are the GET form request, and the SUBMIT form request.

### Handling GET Form Requests

Typically, a GET form request will be accompanied by a form identifier, which may contain information used to identify the site and page that the form exists on. The GET form request may also be invoked by another subsystem of the aggregator or other software codes that require access to forms. The site identifier may be of various forms, including, but not limited to, the URL of the target site, a unique number identifying the site, the name of the site, or any other agreed to convention that is able to uniquely identify the site. The site identifier portion of the GET form request is received by the site identifier component 404, which matches the site identifier to the corresponding normalized format. The site identifier component 404 checks the normalized site identifier against an internal stored list to see whether the site of interest is supported by the system. This internal stored list may be represented in the form of a “white list”, designating the sites that the system supports or a “black list” designating the system that the system does not support or any combination thereof. On making the determination of whether the requested site is supported, if the requested site is not supported, control is passed on to the fall-back handler component 410. Otherwise, the normalized site identifier is sent to the caching service 406.

The caching service 406 receives the normalized site identifier and determines whether the form on the given site is in cache. The caching service 406 does this by accessing the form index database 408, providing the site identifier as a key to the index 408. In one embodiment of the invention form specifications are stored in the form index database 408 as encoded extensible Markup Language (XML) documents. If the appropriate form is found for the site in the index 408, the form specification is retrieved and returned back to the HTTP server 402. If the appropriate form specification is not found in the form index 408, then the caching service 406 sends a request to the agent array 416. The agent array 416 will dispatch the appropriate agent for the site requested and attempt to extract the normalized form specification from the remote form-enabled site. The operation of the agent components will be further described in a subsequent section. If the agent array 416 successfully extracts the form from the remote site, then the resultant form specification is returned back to the HTTP server 402. However, if the agent array 416 is not able to successfully extract the form from the remote site, control is passed back to the fall-back handler 410.

In cases where the normalized form is successfully obtained either from the form index database 408 or from the agent array 416 and passed back to the HTTP server 402, the form is then pre-filled with user information obtained from the form pre-filler 412. The form pre-filler 412 receives from the HTTP server a user identifier, which is used as an index to the user information contained in the user profile database 414. Then, the form specification is translated from the internal representation into an HTML form format suitable to be sent back to the client.

In cases where the normalized form is not successfully obtained, the fall-back handler 410 handles such errors, which can result from different sources. An error can occur because the site requested is not supported by the system, because the site is supported but extraction of the form was not temporarily successful, or for other reasons. In these cases, the fall-back handler 410 deal with the error in multiple ways, such as by re-directing the end user via the HTTP server 402 to the original requested site's URL, thereby presenting the user with the original form on the remote site.

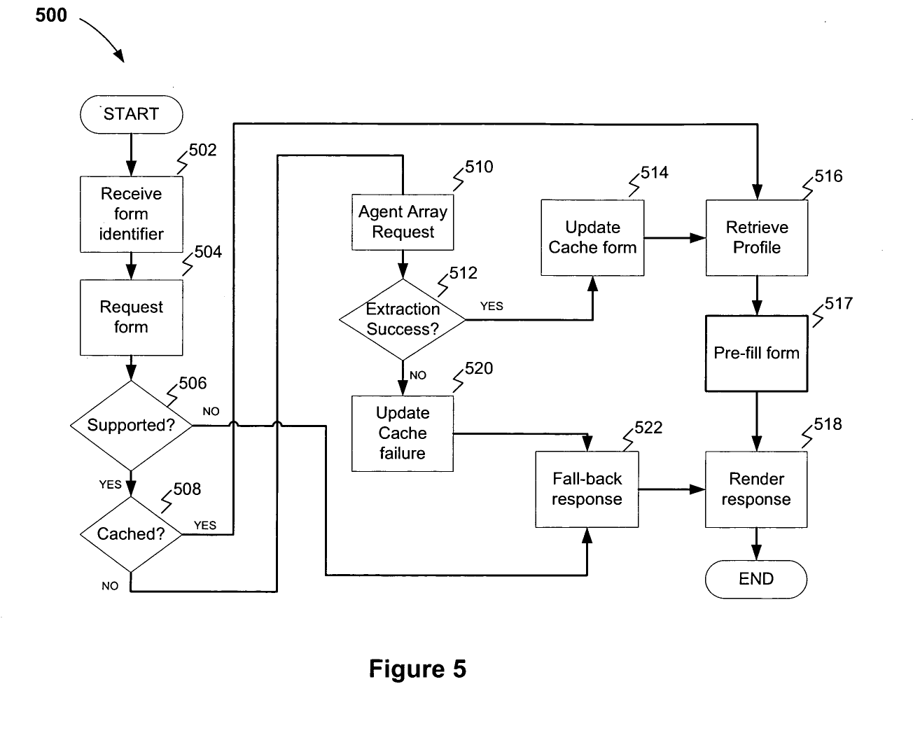

FIG. 5 depicts a simplified flowchart showing further description of the method 500 for handling GET form request from the client. In the first step 502, form identification is received and parsed, which may include information such as the site the form exists on, the URL of the HTML document containing the form, the name of the site, or other information. Then in the second step 504, the form is requested from the form processor subsystem.

First, a check 506 is made as to whether the site that the user has requested a form from is supported. If the site is not supported, the control is passed to the fall-back response process 522. If the site is supported, then a second cache check 508 is performed to determine whether the form that is being requested has been cached. If the form requested is not cached, then the form is obtained from the agent array process 510. The result of the agent array is then checked 512 to determine if the agent array was able to successfully extract the form from the requested site. If the form was successfully extracted, then a form cache update 514 is performed, writing the form into the form cache for cache checks.

If the cache check 508 determines that the form is cached, or the form was not cached, but was successfully obtained by the agent array request 510, then the user profile is retrieved 516. The user profile contains information for pre-filling the fields of the requested form using the correct values for the user that has requested the form. In one embodiment of the invention, the step of retrieving the user profile information 516 is performed after the form specification is obtained. In an alternative embodiment of the invention, the step of retrieving the user profile information is omitted in the case that the user is not identified. In this case, no form pre-filling will happen. In another embodiment of the invention the user profile information retrieval step 516 can be performed before the form specification is obtained. Once the user profile information has been obtained, the next step 517 will be to pre-fill the form with the user profile information by altering the form Document Object Model (DOM) with the appropriate values for the fields given in the user profile. After the form has been pre-filled 517 with the user profile information, the render response 518 process will then take the pre-filled form, translate it from the internal form specification representation into an HTML form format, and wrap it in an HTML document, conforming the aggregator site's customized styling and including any header, footers, navigational elements, etc. of the site's look-and-feel. Alternatively, form pre-filling 517 can occur after the HTML has been rendered in the end-user's web browser by modifying the rendered HTML with the form values.

However, if the extraction process of the agent array was not successfully checked 512, the form cache will instead be updated with a note of failure 520. This failure can occur for several reasons, including that the remote document is not available (HTTP file not found error), or that the extraction routine was not able to locate a form. This step 520 is necessary so that future requests for the same form from the site will be able to fail without having to re-attempt extraction with the agent array. In both cases of updating the form index cache in response to either success or failure, last-modified timestamps may be used so that the agent may re-attempt extraction in case the state has changed.

After the form index failure has been noted 520, the fall-back response is then executed 522, and the failure response is then passed to the HTTP server for rendering 518, which may contain a notice to the user of the failure or simply re-direct the user to the original site.

### Handling SUBMIT Form Requests

Another mode of operation for the form processor 306 is the handling of the SUBMIT form request. In one typical usage of the current embodiment of the invention, an end user invokes a GET form request, retrieving a pre-filled form, completes the returned form, filling out any fields that may not have been pre-filled, and then performs a SUBMIT form request, submitting the completed form back to the aggregator site.

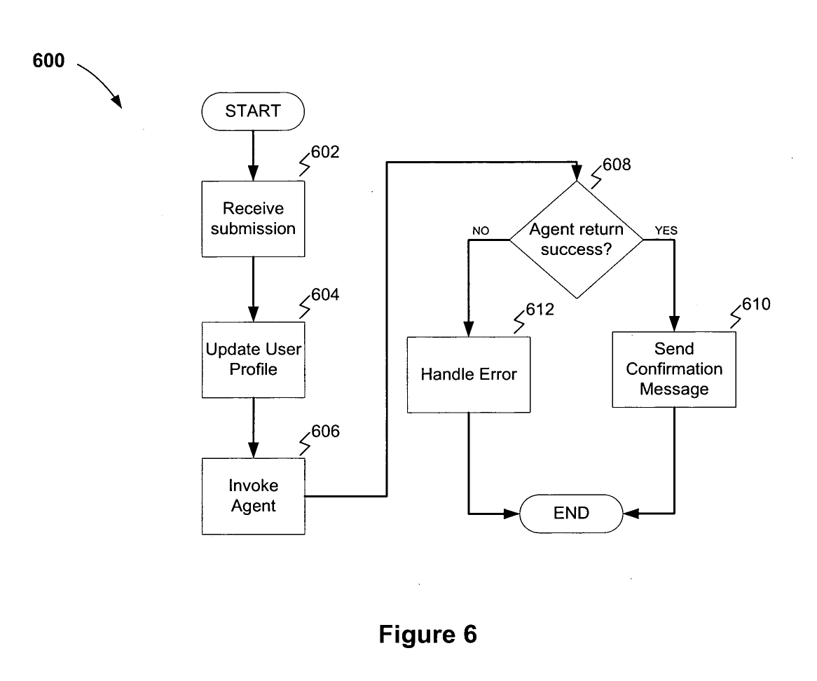

FIG. 6 shows a simplified flowchart that describes in further detail the method 600 of handling a SUBMIT form request by the form processor 400. In the first step 602, the form processor receives the form submission, which may be encapsulated in the form of an HTTP GET or POST request. This submission, which may be encoded in several formats, includes the form identifier and the completed name-value pairs for each of the fields of the form. Once the form submission has been received 602, then the user profile database is updated 604, with the new information, creating a new entry if none had existed beforehand. Next, the corresponding agent is invoked 606, by submitting the form specification to the agent array with the appropriate form or site identifier. The corresponding agent will construct a form using the same format, including the original field names, of the remote form-enabled site and submit the modified form to the remote form-enabled site. Subsequently, the return value of the agent is checked 608. If the agent returns success, then a confirmation message is sent 610, notifying the user his form has been sent. This confirmation message could be in the form of an HTIML document sent back by the HTTP server or alternatively as an e-mail message. If the agent returns failure, then an error-handler is executed 612. This error handler could notify the user via an HTML message or e-mail or take corrective action, such as re-attempting the submission, or notify a system administrator.

### Site-Specific Agents

Further description of agent array embodiments, such as the one 312 referred to in FIG. 3, will now be provided. Site-specific agents are components that handle interfacing specific form-enabled sites. For each form-enabled site, a site-specific agent may be configured programmatically or by automatic configuration. Agents must be highly sophisticated in order to successfully handle modern web sites, which may require HTML rendering, JavaScript execution, and multi-page requests in order to correctly function. Site-specific agents are accessed via an agent array. Agent arrays are collections of site-specific agents that are randomly addressable by a form identifier. The agent components contained within an agent array determine the “white list” of sites that are supported by a form processor.

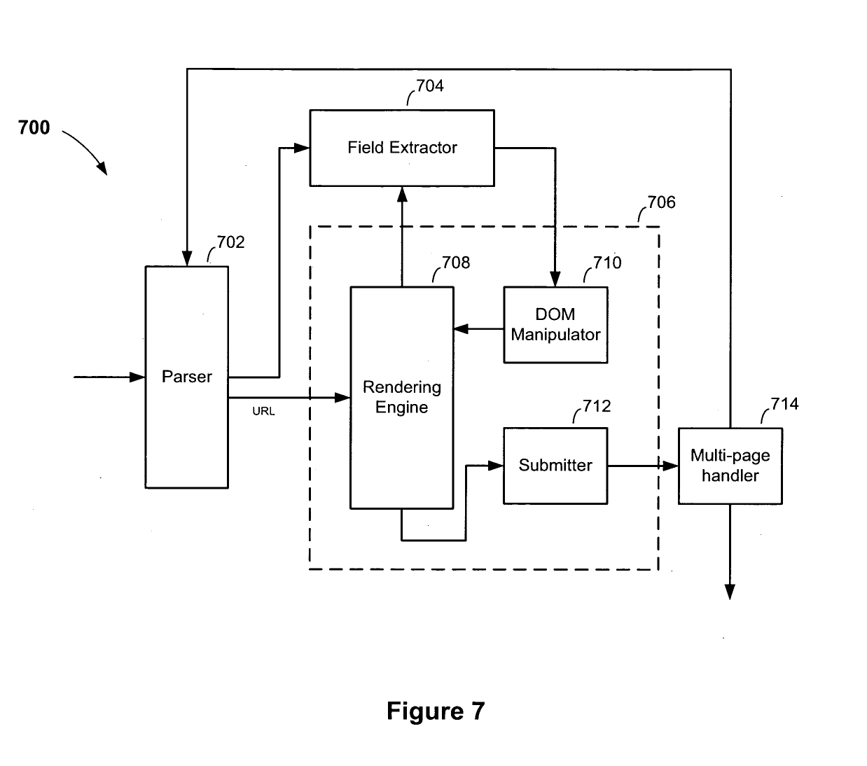

FIG. 7 is a simplified schematic diagram of exemplary site-specific agent architecture 700. A site-specific agent 700 contains a parser 702, field extractor 704, browser simulator 706, and a multi-page handler 714. The browser simulator 706 further comprises a rendering engine 708, DOM manipulator 710, and a submitter 712.

In handling interactions with the remote form-enabled websites, site-specific agents operate on two major types of requests: GET form requests and SUBMIT form requests. In GET form request mode, the exemplary agent 700 operates by receiving the request and using a parser 702 to parse the contents of the request. The request may contain information such as the mode of the agent (GET or SUBMIT), the specific URL to attempt form extraction starting form, or other information. The parser 702 invokes the browser simulator 706 with the URL of the page to request the form from.

The browser simulator 706 is a component that simulates the workings of a web browser software program. Specifically, it attempts to function, as seen by the remote form-enabled website, with the same behavior as a human user operating a web browser. From the perspective of the remote form-enabled website, the operation of the agent should be as indistinguishable as possible from the activity of a real human user of the site. The browser simulator 706 can be implemented in many ways. In one embodiment of the browser simulator 706, it is implemented as a real commercially-used web browser program, such as Microsoft Internet Explorer, Mozilla Firefox, or Opera, with automation scripts to control the web browser program's behavior.

In an alternative embodiment, shown in FIG. 7, the browser simulator 706 is implemented as a set of software modules that mimic the behavior of some subset of web browser software functionality. In this embodiment, the URL parsed from the request is downloaded from the remote form-enabled site, along with any associated files, such as CSS, JavaScript includes, binary images, and embedded data and fed to a rendering engine 708. The rendering engine 708 performs various tasks, such as executing the JavaScript and constructing a Document Object Model (DOM) of the HTML page. The DOM of the webpage is fed to a field extractor 704, which analyzes the DOM and extracts references to the locations of the fields within the form or document.

The field extractor 704 can be configured for each site-specific agent manually, or by automatic means. Using a manual configuration process, the fields can be identified by using HTML element “id” attribute, by using the HTML element tag name, or by XPath query. One skilled in the art will also readily appreciate other techniques for equivalently referencing field elements with a HTML DOM. In particular for HTML forms, another technique for identifying the field element is by first finding the matching “label” element that is associated with a form field and then using the “label” element to locate the field element.

In another embodiment of the invention, the configuration of the field extractor is performed automatically, without manual configuration. This is possible since, in many application domains, field names will share many common characteristics and naming conventions. For example, on a form-enabled job search site, the field corresponding to the input of the user's first name might be given the name “firstName”, or “first”. Locating the set of field elements in this scenario could be accomplished by matching regular expressions against field names or the text nodes surrounding the fields. Other attributes of the field element, such as the “id” or “name” attributes may also be used for matching purposes to guess at the location of fields.

Once the field elements of interest have been extracted by the field extractor 704, if the agent 700 is handling a SUBMIT form request, then the DOM manipulator 706, will alter the DOM by modifying the values of the field references extracted by the field extractor 704 to agree with the user submitted data. The modified DOM is then fed back to the rendering engine 708 to be re-rendered. In this embodiment, a submitter 712 then reads the modified DOM of the page and extracts information about the form submission, such as the URL of the form “action” attribute, method of submission (HTTP GET or POST, for example), and whether the form spans multiple HTML pages. Then, the submitter 712 actually executes the submission by executing any pre-submission Javascript included in the HTML document, retrieving the values of any form fields, both visible and hidden, transmitting the fields of the form in the current modified DOM to the remote form-enabled site, in the appropriate HTTP format (typically POST or GET), and capturing the returning HTTP response from the remote site.

Optionally, a multi-page handler 714 will detect whether the form of the remote site spans multiple HTML pages, by using the information extracted by the submitter 712 in conjunction with the response received from the remote server. If it is determined that the form spans multiple pages, then the next page in the series, being returned by the remote server in response to the submission on the previous page, is fed back to the parser 702, and the above steps in the browser simulation process are repeated anew on this next page. Briefly, the DOM of the new page is rendered by the rendering engine 708, the fields on this new page are extracted by the field extractor 704, the DOM manipulator 710 writes in any fields existing on the page with the values from the user submitted information, and the submitter 712 again detects whether there is a next page and submits the form of the current page.

If the submitter detects that the last page has been reached, possibly by determining that the remote server's response contains no additional forms, then the agent returns back a success code, indicating a successful transaction. If during any of the aforementioned steps, an exception occurs, then the agent will return back an error code, indicating the type of exception. Many different categories of errors are possibly encountered, such as errors originating from the remote site (file not found errors, invalid request errors), errors due to changes in the web page from previously extracted form specifications, errors in parsing data, errors in rendering a DOM, and others.

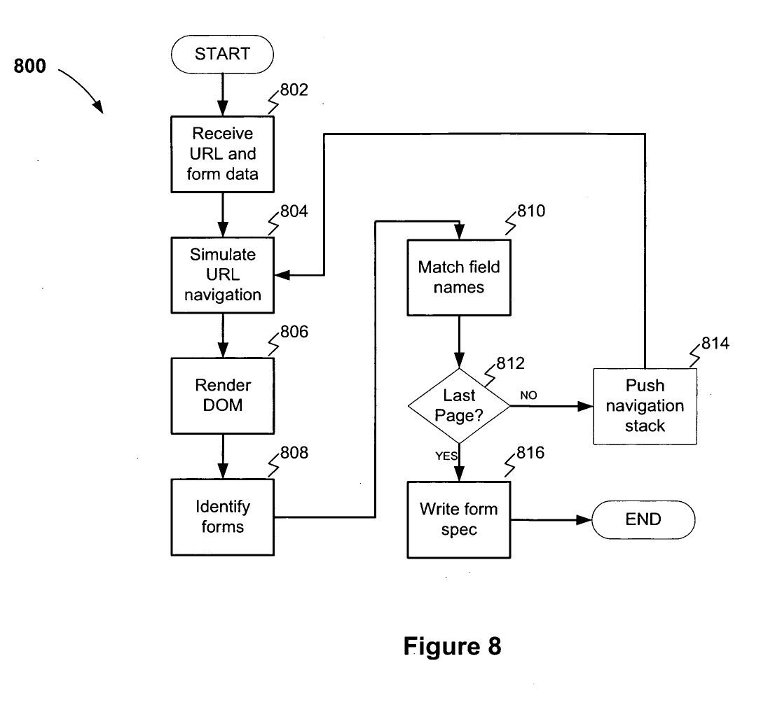

FIG. 8 is a simplified flowchart that depicts in further detail the method 800 of handling a GET form request by a site-specific agent that has been configured to handle the requested site. In the first step 802, user-submitted form data and site and form metadata, such as the URL are received and parsed. Second, URL navigation 804 is simulated by downloading the document located at the given URL and any associated files that may be referenced, either directly or indirectly, by the resultant HTML document. The data obtained by this step is then rendered 806 into a Document Object Model (DOM), by constructing the tree representation of the HTML document, applying any CSS selector rules, executing any JavaScript functions, and computing layout geometry, among other steps. Next a process 808 is run on the rendered DOM, which identifies the presence of forms 808. This may be accomplished by searching for a “form” tag in the rendered DOM. In the next step 810, the references to the field elements of the form in the rendered DOM are determined. In a manually configured site-specific agent, the location of the field elements in the DOM for each field are specified in advance using well-known DOM selection methods, such as selecting by the “id” attribute, tag name, associated field “label” element, or XPath location. In an automatically configured site-specific agent, the location of the field elements are determined by attempting to match regular expression patterns against attributes and tag names of the field elements, associated “labels”, or surrounding text.

Next, a check is performed to determine whether the current page is the last page of the form 812. This can be accomplished by actually submitting the form with dummy information to the remote site and capturing the HTTP response received to determine whether the received HTTP response contains a continuation of the form of interest. If it is determined that the current page is not the last page, then the details of the current page, such as the URL and field element locations are pushed 814 onto a navigation stack object, and the process starts again from the navigation step 804. This loop may repeat an unlimited number of times, each time pushing a new page information element onto the navigation stack, indicating each HTTP submission required in a multi-page form. Once the last page check 812 has determined that the current page is the last page in the form, then the navigation stack is converted into a normalized form specification, indicating the field names, element locations, URLs and form submission methods, field validation requirements, and other information that are necessary in order to manipulate the DOM and submit the form to the remote form-enabled site.

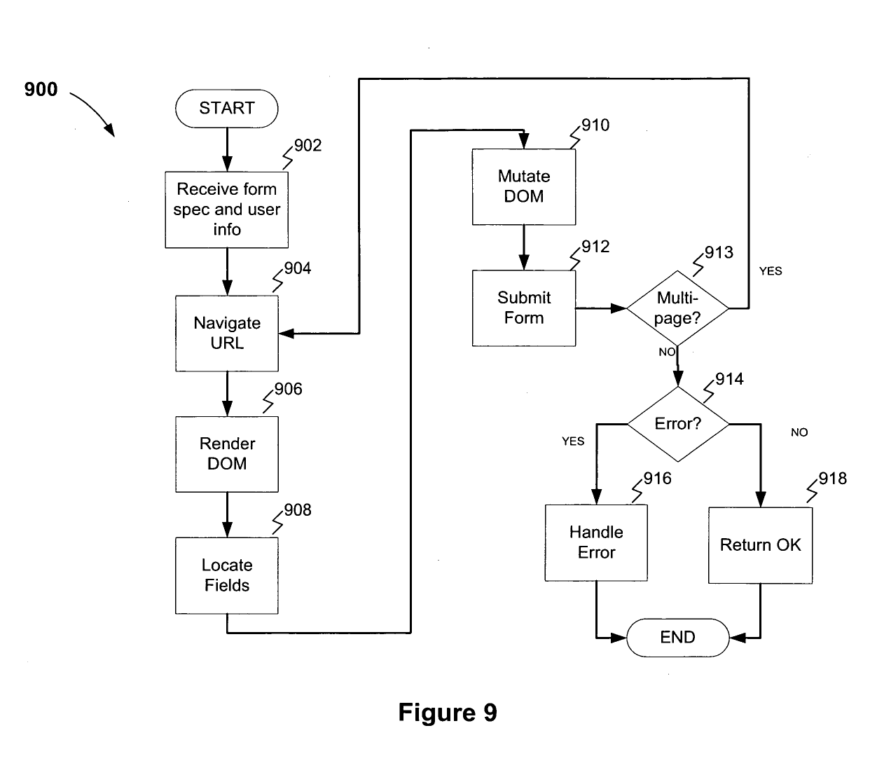

In another operation mode, the site-specific agent handles SUBMIT form requests. FIG. 9 is a simplified flowchart depicting further detail on the form submission process 900. In the first step 902, user submitted data and the normalized form specification, such as that generated by method 800, are received and parsed. Secondly, the first page of the form specification is navigated to 904 by downloading the page located at the remote URL and any associated files referenced by the given page. Next, a DOM for the page is generated 906 by constructing the tree representation of the HTML document, applying any CSS selector rules, executing any JavaScript functions, and computing layout geometry, among other steps. Subsequently, the field elements of the form on the current rendered DOM are obtained 908 by locators given in the current step of the form specification, such as by running the XPath or other selector. Next the rendered DOM is then mutated 910 at the location of each of the selected form elements with the values contained in the user submitted data. Optionally, the normalized field names are translated into the associated field names used by the form-enabled site. Next, the current page is submitted 912, using the HTTP method that is given in the current step of the form specification. After the submission and a response has been received by the remote server, A check 913 is performed to see whether there is a next step in the form specification, indicating a multi-page form. If there is a next step, then the current step is popped of the form specification, and the navigation step 904 is returned to. If the last page has been reached, then the loop ends.

After the main form submission loop has been performed, a check is made as to whether any errors occurred in the process of submission 914. Many species of errors may occur. These include remote server errors (such as File not found, bad request, unauthorized user, etc), errors in the user submitted data (such as wrong number of digits in a zip code), errors in parsing the data and rendering the DOM, unexpected conflicts between the form specification and the current rendered DOM, and many other types. If it has been determined that an error has occurred, then the error must be appropriately handled 916. This may be in the form of an e-mail notification to the user, a prompt to the user to re-try the submission, or a fall-back redirecting to the original URL of the form-enabled site. Otherwise, a confirmation of the submission 918 is sent to the user notifying him of a successful submission of his form data.

### Integrations and Applications

While the automatic form interface manager and site-specific agent architecture described in the foregoing description may be used to improve the functionality of aggregator sites, the technology can be integrated in many different ways, providing a seamless enhancement in several applications.

One embodiment of the invention contemplates using the automatic form interface management system on an existing aggregator site by simply inclusion of a reference to the URL of the web interface, thereby rendering the web interface window within an existing aggregator site served by a separate web host. There are many methods in which such an inclusion could be made from an existing, separately hosted, site. In one method, this inclusion is performed by an appropriate reference in an HTML “iframe” tag. In this implementation, the automatic form interface management system is hosted on a standalone web server. Third-party aggregator sites can then simply integrate the functionality of the system by referencing the service via an “iframe”. The URL referenced in the iframe may encode the GET form request along with form and user identifiers. This allows the third-party aggregator to maintain the look and branding of the outer frame, while having the enhanced benefits provided by the automatic form interface manager for accessing external form submissions. Another benefit of this implementation is that many third-party aggregators currently already employ iframes as a means for showing the external forms, so making a change to have the iframe reference the automatic form interface manager would be a simple modification. Alternatively, access to the automatic form interface management system can be included by similarly invoking a “popup” window from the third-party aggregator site. In this embodiment, the third-party aggregator site can cause the client web browser to create a separate window, rendering the contents of the automatic form interface manager system, by using scripting or other interaction browser code. Other methods of integration, such as inclusion of the rendered content from the automatic form interface manager into the third-party site using asynchronous Javascript-initiated HTTP requests, are also possible.

Another embodiment of the invention contemplates hosting the automatic form interface management system on a standalone server and exposing functionality via a web services application programming interface (API). Third-party aggregators may utilize the automatic form interface management system by calling the API from code on their own servers, including requests to get and submit forms. This web services API could be implemented using various protocols well known to those of skill in the art including, but not limited to, XML Representational State Transfer (REST), Service Oriented Architecture Protocol (SOAP), Remote Procedure Calls (RPC), etc. While this embodiment may require more effort to integrate with the third-party aggregator and a tighter integration with the application logic, it has many benefits over the previous embodiment, since the aggregator has total control over the user interface, obtaining the ability to display the unified forms in their own style and having more flexible control over the layout of the page, and handling of submission confirmations and submission errors.

An additional embodiment of the invention contemplates using the automatic form interface manager directly by the end user without even requiring the integration with the aggregator. In this embodiment of the invention, the end user himself installs a web browser plugin. Web browser plugins are specialized software modules that allow extension of the functionality of web browser clients and are currently common in the most popular commercial web browsers. In this implementation, the web browser plugin detects when the user has navigated to a web site, retrieving the URL of the site that he is navigating to. Then, the plugin uses the URL to determine whether the current site is one that is supported by the automatic form interface management system. This can be accomplished by having the web browser plugin store a “whitelist” of URL regular expression patterns that it checks the current URL against or having the plugin send the URL to the hosted automatic form interface manger server via a web services API to determine whether the current site is supported.

If it is determined that the current site that the user wishes to navigate to is supported, the plugin then intercepts the navigation request and re-directs the web browser program to the corresponding GET form request on the automatic form interface manager server. The user benefits, since he views a unified form style, with the fields in the form already pre-filled with his information. Additionally, this arrangement does not require the user to be using a specific third-party aggregator service, but may have followed the link to the supported form-enabled service from any site.

Lastly, web browser client programs that do not have a programmatic plugin extensibility feature may also implement an end user installed version by running in-browser script. Many web browser software clients support script “bookmarklets”, which are specialized bookmark files that contain code written in a scripting language that is executed when the bookmark file is invoked from the web browser program. Bookmarklet support is found in many popular commercial web browser programs. In this implementation, when a user encounters a form on a supported form-enabled site, he simply invokes a customized bookmarklet, which runs script that re-directs the browser to the version of the form hosted on the automatic form interface manager server.

While the above is a complete description of the preferred embodiments of the invention sufficiently detailed to enable those skilled in the art to build and implement the system, it should be understood that various changes, substitutions, and alterations may be made without departing from the spirit and scope of the invention as defined by the appended claims.

What is claimed:

1. A automatic form interface manager, comprising:
a form processor configured to receive requests from a web browser client software;
a database of user submitted profile data; and
an agent array,
wherein said form processor is configured to access said database of user submitted profile data and said agent array.

2. The apparatus of claim 1 further comprising a database of cached form specifications wherein said form processor is configured to access said database of cached form specifications.

3. The apparatus of claim 2 wherein said form processor handles requests from a web browser client of type including: get form request and submit form requests.

4. The apparatus of claim 3 wherein said agent array comprises a plurality of site-specific agents, wherein the agent array is capable of randomly addressing and dispatching messages to each of the site-specific agents.

5. The apparatus of claim 4 wherein said form processor includes a form pre-filler operable to fill in the values of field elements on retrieved forms with the data retrieved from the database of user submitted profile data.

6. The apparatus of claim 5 wherein said database of user submitted profile data is implemented as a relational database management system.

7. The apparatus of claim 5 wherein said database of user submitted profile data is implemented as a relational database management system.

8. A site-specific agent comprising:
a parser, configured to receive data such as a form identifier and user submitted data;
a field extractor;
a browser simulator capable of navigating a corresponding page referenced by the form identifier and generating a Document Object Model of the page; and
a multi-page handler,
wherein said parser is operable to parse a form identifier and pass the form identifier to a browser simulator and said field extractor is capable of locating pre-specified fields in the Documents Object Model generated by the browser simulator.

9. The apparatus of claim 8 wherein the field extractor is able to extract references to field element nodes in the Document Object Model by a plurality of node location selectors.

10. The apparatus of claim 9 wherein said node location selectors are manually configured for each site.

11. The apparatus of claim 9 wherein said node location selectors are automatically generated using pattern matching.

12. The apparatus of claim 8 wherein said browser simulator further comprises:
a rendering engine, able to render a Document Object Model from a collection of web documents;
a Document Object Model manipulator; and
a submitter,
wherein said submitter is configured to analyze the rendered Document Object Model, transmit the form to a remote web server, and determine whether the form spans multiple web pages.

13. A method for retrieving a form associated with a given form identifier comprising the steps:
determining whether the corresponding web site of the given form identifier is supported;
determining whether a form specification for the form identifier is cached in a form cache;
retrieving the form specification for the given form identifier from an agent array;
updating the state of the form cache to reflect the availability of said form specification; and
generating a form using the fields given in the form specification with values obtained from a user profile database.

14. The method of claim 13 where the step of retrieving the form specification from an agent array for a given form identifier comprises:
simulating navigation of the corresponding web page of the form identifier;
rendering a Document Object Model of the corresponding web page;
analyzing the said Document Object Model to identify the location of HTML forms; and
extracting the names and attributes of field elements in the identified forms.

15. A method for submitting an end user submitted form specification comprising the steps:
updating a user profile database with the values for the fields contained in the end user submitted form specification;
invoking a site-specific agent with the end user submitted form specification;
receiving a return state of the site-specific agent; and
presenting the return state of the site-specific agent to the end user.

16. The method of claim 15 wherein the step of invoking a site-specific agent further comprises:
simulating navigation of the corresponding web page of the form identifier contained in the form specification;
rendering a Document Object Model of the corresponding web page;
locating the form fields in the Document Object Model using the selectors given in the form specification;
altering the Document Object Model with the corresponding user-submitted values in the form specification; and
submitting the altered form of the Document Object Model to a remote web server.

17. A method of enabling access to an automatic form interface manager comprising inserting a reference to a server hosting the automatic form interface manager in a HyperText Markup Language document.

18. A method of enabling access to an automatic form interface manager comprising a making a call to a web services application programming interface on a remote server, wherein said server is hosting the automatic form interface manager.

19. A method of enabling access to an automatic form interface manager comprising creating a web browser program plugin, wherein said plugin is configured to redirect the web browser program to a web server hosting the automatic form interface manager.
